(19) United States
(12) Patent Application Publication
(10) Pub. No.: US 2015/0069004 A1
(43) Pub. Date: Mar. 12, 2015

(54) CAP FOR FEEDING BOTTLE

(71) Applicant: BB lPR Limited, Stanmore, Middlesex (GB)

(72) Inventor: Stephen Paul Tollman, Stanmore (GB)

(21) Appl. No.: 14/386,760

(22) PCT Filed: Mar. 27, 2013
(86) PCT No.: PCT/GB13/50807

§ 371 Date: Sep. 19, 2014

(30) Foreign Application Priority Data
Mar. 31, 2012 (GB) 1205810.3

(51) Int. Cl. A61J 11/00

(52) U.S. Cl. CPC A61J 11/00
USPC 215/11.1

(57) ABSTRACT

The removable cap for a feeding bottle is made from flexible plastics material with a smooth exterior surface which is soft to a baby's lips and chin and has an upstanding nipple open at the bottom and with an aperture at the top. The underside of the cap is provided with a plurality of spaced shallow indentations elliptical in shape and moulded into the plastics material. The indentations are arranged in concentric circles around the open end of the nipple and increase in length and width progressively from the innermost circle to the outermost circle.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The invention relates to a removable cap for the top of a feeding bottle used for babies. The cap carries an upstanding nipple which is open at the bottom for the inflow of the liquid bottle contents and an aperture at the top for the outflow of the contents into the baby's mouth when it sucks on the nipple.

2. Description of Related Art Including Information Disclosed Under 37 CFR 1.97 and 37 CFR 1.98.

The aim of the present invention is to provide such a cap which more realistically replicates the feel of a mother's breast and nipple than is achieved by conventional feeding bottles.

### SUMMARY OF THE INVENTION

According to the invention, the removable cap is constructed of flexible plastics material and has a smooth exterior surface which is soft to the touch of the baby's lips and chin and an area of which surrounding the open end of the nipple is provided in its underside with a plurality of spaced shallow indentations which are elliptical in shape.

By means of the invention, the area of the cap around the nipple has an enhanced flexibility in comparison with the remainder of the cap and can flex and stretch upwardly together with the nipple while suction is applied, also allowing the nipple to tilt as the baby's mouth is moved. As a result, the nipple moves like a mother's nipple and affords baby a more natural breast-like feeding experience. When the suction ceases, the cap returns to its unflexed state.

The indentations are moulded into the cap during manufacture and the preferred plastics material is silicone.

### BRIEF DESCRIPTION OF THE DRAWINGS

An example of the invention will now be described with reference to the accompanying drawing.

FIG. 1 is a bottom plan view of the cap when removed from the bottle.

FIG. 2 is an upper perspective view of the cap.

FIG. 3 is the same upper perspective view as in FIG. 2 but showing the cap as it would look when suction is applied at the nipple by the baby.

### DETAILED DESCRIPTION OF THE DRAWINGS

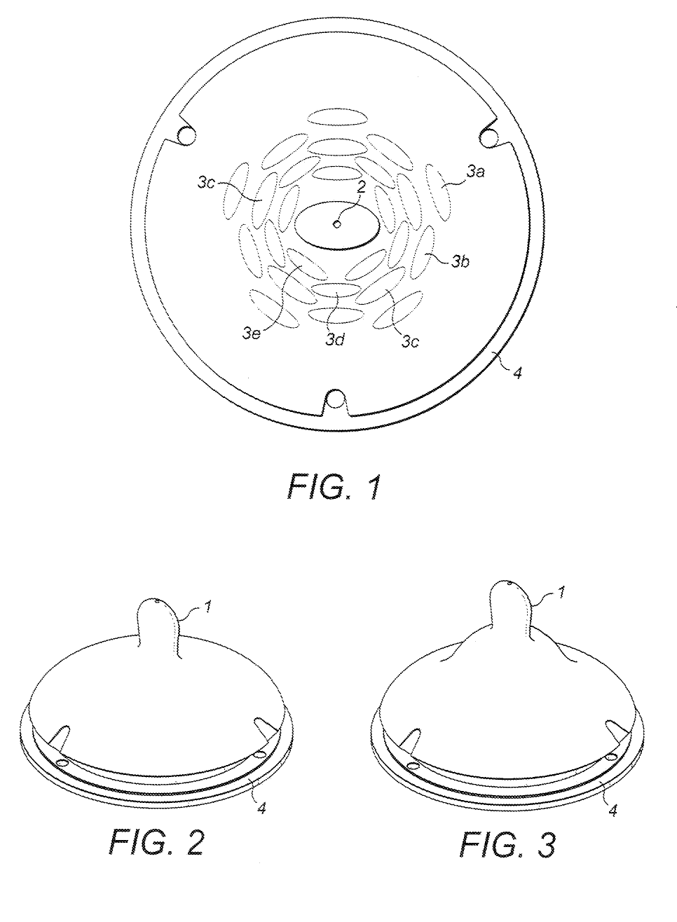

The illustrated circular cap for applying to the top of a baby's feeding bottle is substantially segmentary domical in shape and moulded in silicone material with a smooth exterior surface which is soft to the touch of the baby's lips and chin. Upstanding from its apex there is an integral oval-shaped nipple 1 with an aperture 2. In the enlarged FIG. 1 view, only the interior of the nipple is visible through its open end.

In an area of the cap surrounding the open end of the nipple, the underside of the cap is provided with a plurality of spaced shallow elliptical indentations formed during moulding of the cap. As shown in the FIG. 1 embodiment, which illustrates a favourable arrangement of the indentations, they are disposed in five concentric circles around the nipple and they increase in length and width progressively from the indentations 3e in the innermost circle to the indentations 3d, 3c, 3b and finally 3a in the outermost circle. This arrangement has been found to be most effective.

FIG. 3 illustrates the cap in its condition when suction s applied to the nipple 1, with the area supporting the nipple flexed and stretched to upstand from the remainder of the material whereas in FIG. 2 the cap is shown in its unflexed state.

The cap is removably attached to the neck of a feeding bottle by means of a separate ring (not shown) which engages a peripheral flange 4 on the cap.

1. A removable cap for a top of a feeding bottle used for babies, comprising:
an upstanding nipple open at a bottom for inflow of liquid bottle contents; and
an aperture at a top for outflow of the contents into a baby's mouth when a baby sucks on the nipple,
wherein the nipple and aperture are comprised of flexible plastics material, having a smooth exterior surface being soft to a touch for lips and chin of the baby and an area surrounding an open end of the nipple being provided with a plurality of spaced shallow indentations elliptical in shape and moulded into the plastics material on an underside of the nipple, the indentations being arranged in concentric circles around the open end of the nipple and increasing in length and width progressively from an innermost circle to an outermost circle.

2. The cap according to claim 1, wherein the flexible plastics material is comprised of silicone.
